(19) United States
(12) Patent Application Publication
(10) Pub. No.: US 2026/0261773 A1
(43) Pub. Date: Sep. 3, 2026

(54) PIXEL CIRCUIT INCLUDING TWO COMPARATOR CIRCUITS FOR EVENT DETECTION AND IMAGE SENSOR

(71) Applicant: Sony Semiconductor Solutions Corporation, Kanagawa (JP)

(72) Inventors: Raphael BERNER, Stuttgart (DE); Massimo ZANNONI, Stuttgart (DE)

(73) Assignee: Sony Semiconductor Solutions Corporation, Kanagawa (JP)

(21) Appl. No.: 19/157,707

(22) PCT Filed: Mar. 4, 2024
(86) PCT No.: PCT/EP2024/055611

§ 371 Date: Aug. 19, 2025

(30) Foreign Application Priority Data
Mar. 17, 2023 (EP) 23162724.1

(51) Int. Cl. H04N 25/47; H04N 25/707; H04N 25/767

(52) U.S. Cl. CPC H04N 25/47; H04N 25/707; H04N 25/767

(57) ABSTRACT

A pixel circuit includes a radiation sensitive circuit that converts a change of incident radiation into a pixel voltage signal VPR, wherein the pixel voltage signal VPR increases with increasing radiation intensity. A first capacitive element receives the pixel voltage signal VPR at a first electrode. A second capacitive element receives the pixel voltage signal VPR at a first electrode simultaneously with the first capacitive element. A first comparator circuit compares a first resettable voltage at a second electrode of the first capacitive element with a first threshold voltage VTH. A second comparator circuit compares a second resettable voltage at a second electrode of the second capacitive element with a second threshold voltage VTL.

The present disclosure relates to a pixel circuit with two comparator circuits for event detection, and to an image sensor. More particularly, the present disclosure relates to the field of event detection sensors that respond to predefined changes in light intensity, such as dynamic vision sensors (DVS) and event-based vision sensors (EVS).

### BACKGROUND

Event detection image sensors like DVS and EVS deliver information about the position of predefined changes in the imaged scene. Unlike image sensors that transfer large amounts of image information in frames, transfer of information about pixels that do not change can be omitted, resulting in a sort of in-pixel data compression. The in-pixel data compression removes data redundancy and facilitates high temporal resolution, low latency, low power consumption, high dynamic range, and little motion blur.

Pixel circuits for DVS and EVS detect ON events indicating an increase in radiation intensity by at least a predefined step-up value and OFF events indicating a decrease in radiation intensity by at least the predefined step-down value. EVS pixel circuits with a single comparator sequentially compare a differential voltage derived from the current radiation intensity and a previous radiation intensity to a first threshold voltage to check for ON events and to a second threshold to check for OFF events. EVS pixel circuits with a capacitive amplifier typically use two parallel comparators that can simultaneously test for ON events and for OFF events.

An EVS pixel circuit that detects an ON event or an OFF event stores the event until the pixel circuit is next read. Each time a pixel circuit is read, the event is cleared. Clearing the event typically includes an automatic zeroing process (“autozero process”, “autozeroing”) that resets the differential voltage to a new initial value.

### SUMMARY

In EVS pixel circuits with a capacitive amplifier, an electronic reset switch short-circuits the output and the input of the capacitive amplifier for autozeroing. The output signal of the capacitive amplifier can be simultaneously applied to the inputs of two comparator circuits. The two comparator circuits allow continuous detection and thus achieve a high time resolution in the order of a few microseconds in good lighting conditions. Process, power consumption and area constraints usually limit the gain of the capacitive amplifier. The comparatively small gain limits the range of contrast sensitivity and the pixel-to-pixel contrast sensitivity non-uniformity resulting from pixel-to-pixel differences in threshold voltages is comparatively high.

In pixel circuits with a single comparator, an electronic reset switch connects a first input of the comparator with a predefined potential for autozeroing. Threshold defining voltages defining the threshold voltages for the ON event and the OFF event are sequentially applied to the second input of the comparator in a detection period. Due to the absence of a feedback loop, the gain across the comparator is comparatively high. The comparatively high gain expands the range of contrast sensitivities and reduces the effects of pixel-to-pixel threshold voltage differences such that comparator sensitivity non-uniformity can be small. Since the threshold defining voltages can only be sequentially applied to the second input of the comparator, no continuous detection is possible and thus time resolution is comparatively low.

The present technology has been made in view of this situation and aims to improve the performance of pixel circuits for event detection.

In this regard, the present disclosure relates to a pixel circuit that includes a radiation sensitive circuit. The radiation sensitive circuit converts a change of incident radiation into a pixel voltage signal VPR, wherein the pixel voltage signal VPR increases with increasing radiation intensity. A first capacitive element receives the pixel voltage signal VPR at a first electrode. A second capacitive element receives the pixel voltage signal VPR at a first electrode simultaneously with the first capacitive element. A first comparator circuit compares a first resettable voltage at a second electrode of the first capacitive element with the first threshold voltage VTH. A second comparator circuit compares a second resettable voltage at a second electrode of the second capacitive element with a second threshold voltage VTL.

Since the two comparator circuits can simultaneously check a differential voltage derived from the pixel voltage signal VPR for ON and OFF events, the pixel circuit allows continuous detection and achieves high temporal resolution. The high gain across each comparator circuit expands the range of contrast sensitivity, reduces the effects of pixel-to-pixel threshold voltage differences and therefore can provide low contrast sensitivity non-uniformity.

The described embodiments, together with further advantages, will be best understood by reference to the following detailed description taken in conjunction with the accompanying drawings.

### BRIEF DESCRIPTION OF THE DRAWINGS

FIG. 1 is a schematic diagram illustrating a configuration example of an imaging apparatus as an electronic device including a solid-state imaging device with pixel circuits according to the embodiments.

FIG. 2 is a simplified block diagram illustrating a configuration example of a solid-state imaging device in accordance with an embodiment with pixel circuits for continuous detection integrated in an image sensor for synchronous readout.

FIG. 3 is a simplified block diagram illustrating a configuration example of a solid-state imaging device in accordance with an embodiment with pixel circuits for continuous detection integrated in an image sensor for asynchronous readout.

FIG. 4 is a schematic diagram illustrating an embodiment in which a solid-state imaging device has a two-layer structure in a stacked CIS configuration.

FIG. 5 is a simplified circuit diagram illustrating a configuration example of a pixel circuit with two capacitive elements and two parallel comparator circuits for continuous detection in accordance with an embodiment.

FIG. 6 is a simplified circuit diagram illustrating a configuration example of a pixel circuit with two capacitive elements and two parallel comparator circuits for continuous detection and with two reset switches short-circuiting input and output of each comparator circuit in an autozero period in accordance with an embodiment.

FIG. 7 is a simplified circuit block diagram illustrating a configuration example of a pixel circuit with two capacitive elements and two parallel comparator circuits for continuous detection in accordance with an embodiment providing a common autozero switch signal.

FIG. 8 is a simplified circuit diagram illustrating a configuration example of a pixel circuit with two capacitive elements and two parallel comparator circuits for continuous detection in accordance with an embodiment providing complementary autozero switch signals.

FIG. 9 is a simplified circuit diagram illustrating a configuration example of a pixel circuit with two capacitive elements and two parallel comparator circuits for continuous detection in accordance with an embodiment providing multiplexer circuits for controlling inputs of the comparator circuits.

FIG. 10 is a simplified circuit diagram illustrating a configuration example of a pixel circuit with two capacitive elements and two parallel comparator circuits for continuous detection in accordance with an embodiment based on two two-transistor comparator circuits with the same polarity.

FIG. 11 is a simplified circuit diagram illustrating a configuration example of a pixel circuit with two capacitive elements and two parallel comparator circuits for continuous detection in accordance with an embodiment based on two two-transistor comparator circuits with complementary polarity.

FIG. 12 is a simplified circuit diagram illustrating a configuration example of a pixel circuit with two capacitive elements and two parallel comparator circuits for continuous detection in accordance with an embodiment with a pixel logic circuit for synchronous readout.

FIG. 13 is a simplified circuit diagram illustrating a configuration example of a pixel circuit with two capacitive elements and two parallel comparator circuits for continuous detection in accordance with an embodiment with a pixel logic circuit for asynchronous readout.

FIG. 14 is a time diagram for illustrating a method of operating an image sensor with pixel circuits as illustrated in FIG. 13 in accordance with an embodiment.

FIG. 15 is a time diagram for illustrating a method of operating an image sensor with complementary autozero switch signals as illustrated in FIG. 8 in accordance with an embodiment.

FIG. 16 is a circuit diagram of a radiation sensitive circuit of a pixel circuit in accordance with an embodiment and illustrates a distribution of elements of the pixel circuit on two different semiconductor chips in accordance with an embodiment providing one through-contact via per pixel circuit.

FIG. 17 is a schematic circuit diagram for illustrating a distribution of elements of a pixel circuit on two different semiconductor chips in accordance with an embodiment providing two through-contact vias per pixel circuit.

FIG. 18 is a schematic circuit diagram for illustrating a distribution of elements of a pixel circuit on two different semiconductor chips in accordance with an embodiment providing three through-contact vias per pixel circuit.

FIG. 19 is a block diagram depicting an example of a schematic configuration of a vehicle control system.

FIG. 20 is a diagram of assistance in explaining an example of installation positions of an outside-vehicle information detecting section and an imaging section of the vehicle control system of FIG. 19.

### DETAILED DESCRIPTION

Embodiments for implementing techniques of the present disclosure will be described below in detail using the drawings. The techniques of the present disclosure are not limited to the described embodiments, and various numerical values and the like in the embodiments are illustrative only. The same elements and elements with the same functions are denoted by the same reference signs. Duplicate descriptions are omitted.

Connected electronic elements may be electrically connected through a direct and permanent low-resistive connection, e.g., through a conductive line. The terms “connected”, “electrically connected” and “signal-connected” may also include a connection through other electronic elements provided and suitable for permanent and/or temporary signal transmission and/or transmission of energy. For example, electronic elements may be electrically connected or signal-connected through resistors, capacitors, and electronic switches such as transistors or transistor circuits, e.g., MOSFETs, transmission gates, and others.

The load path of a transistor is the controlled current path through a transistor. For example, a voltage applied to the gate of a field effect transistor (FET) controls the current flow through the load path (controlled path) between source and drain of the FET by field effect.

A digital signal alternates between at least one active level and at least one passive level. A digital signal having an active level is active. A digital signal having an inactive level is inactive. The active level can be a digital high level or a digital low level. The inactive level can be a digital low level or a digital high level.

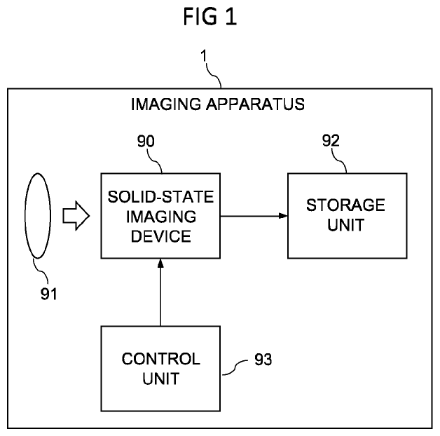

In FIG. 1, an imaging apparatus 1 includes an optical system 91, a solid-state imaging device 90, a storage unit 92, and a control unit 93. The optical system 91 includes one or more lenses and various mechanisms such as an autofocus mechanism and a diaphragm mechanism, and guides light from an object to a light receiving surface of the solid-state imaging device 90.

The solid-state imaging device 90 includes an image sensor having a plurality of pixel circuits. Each pixel circuit includes a photoelectric conversion element that converts incident radiation into electric signals by photoelectric conversion, and outputs the electric signals. The solid-state imaging device 90 further includes a signal processing unit that performs predetermined signal processing on the electric signals output from the pixel circuits and outputs image data based on the electric signals.

The storage unit 92 stores the image data output from the solid-state imaging device 90 in a storage medium. The storage medium may include a volatile storage medium and/or non-volatile storage medium. The non-volatile storage medium may be or include a flash memory or a hard disk drive. The non-volatile storage medium may be or include a dynamic random access memory (DRAM).

The control unit 93 controls the solid-state imaging device 90, such that the solid-state imaging device 90 performs an imaging operation. The imaging operation includes capturing an image of an object or a scene and outputting image data including image information about changes in the appearance of the object or in the scene.

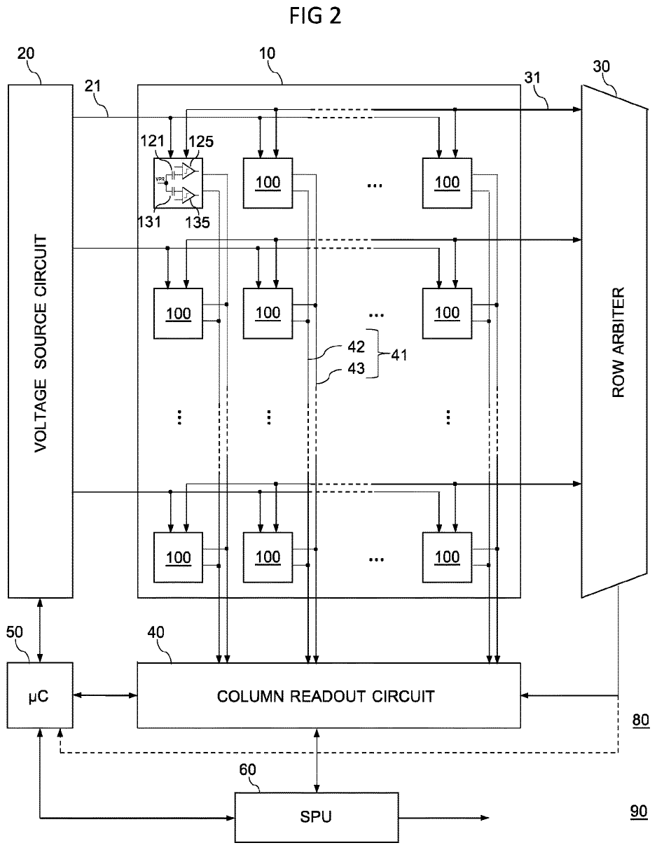

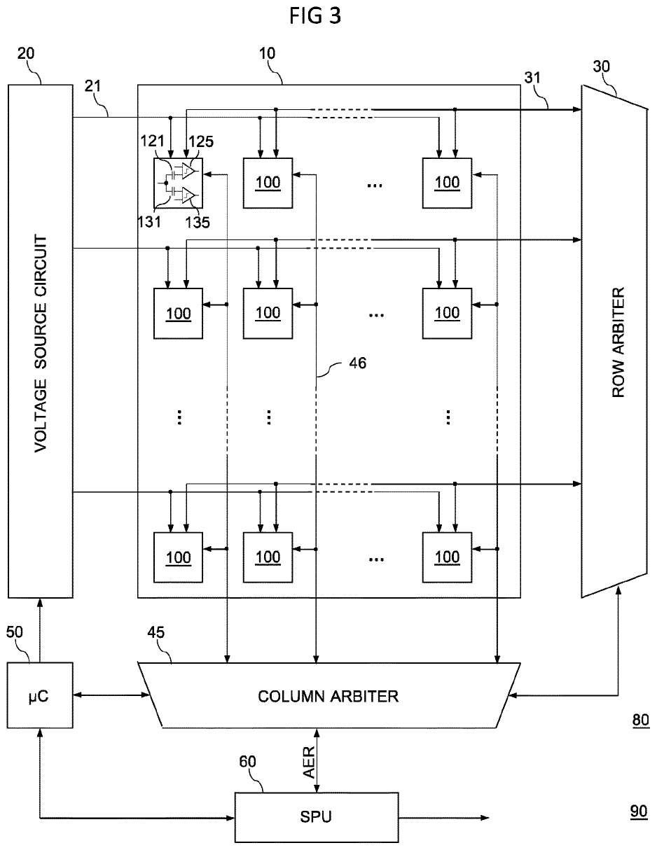

FIG. 2 and FIG. 3 are block diagrams illustrating configuration examples of a solid-state imaging device 90 with an image sensor 80 that includes pixel circuits 100 according to the present embodiments. The solid-state imaging device 90 includes the image sensor 80 and a signal processing unit 60. The image sensor 80 includes a pixel array 10, a voltage source circuit 20, a row arbiter 30, and a sensor control circuit 50.

In the pixel array 10, a plurality of pixel circuits 100 is arrayed in a two-dimensional matrix in pixel rows and pixel columns. For simplicity, pixel circuits 100 belonging to the same pixel row are arranged along a horizontal line in FIG. 2 and FIG. 3, and pixel circuits 100 belonging to the same pixel column are arranged along a vertical line in FIG. 2 and FIG. 3.

Each pixel circuit 100 includes a radiation sensitive circuit, event detection circuits, and a pixel logic circuit. The radiation sensitive circuit outputs a voltage corresponding to the intensity of received radiation. The event detection circuits detect events based on the magnitude of changes in a pixel voltage signal received from the radiation sensitive circuit.

In particular, the radiation sensitive circuit converts incident radiation into a pixel voltage signal VPR, wherein the pixel voltage signal VPR increases with increasing radiation intensity. A first capacitive element 121 of a first event detection circuit receives the pixel voltage signal VPR at a first electrode. A second capacitive element 131 of a second event detection circuit receives the pixel voltage signal VPR at a first electrode simultaneously with the first electrode of the first capacitive element 121. A first comparator circuit 125 compares a first resettable voltage at a second electrode of the first capacitive element 121 with a first threshold voltage. A second comparator circuit 135 compares a second resettable voltage at a second electrode of the second capacitive element 121 with a second threshold voltage VTL.

Each event detection circuit is resettable to an initial state by temporarily turning on a reset switch that resets the resettable voltage during autozeroing. A pixel logic circuit controls the output of event data from the pixel circuit 100 and the autozeroing of the event detection circuits.

The event data may indicate that the intensity of incident radiation has decreased by more than a certain value compared to the previous event readout (“OFF event”). Alternatively, the event data may indicate that the intensity of incident radiation has increased by more than a certain value compared to the magnitude at the previous event readout (“ON event”).

The voltage source circuit 20 generates one or more fixed or in a predefined way changing analog voltages and outputs the analog voltages to groups of pixel circuits 100 through voltage conductor lines 21. A group of pixel circuits 100 can include some or all pixel circuits 100 of a pixel row, the pixel circuits 100 of more than one pixel row, or all pixel circuits 100 of the pixel array 10.

FIG. 2 concerns an image sensor 80 for synchronous readout. Group control buses 31 connect the pixel circuits 100 with the row arbiter 30. Each group control bus 31 connects the pixel circuits 100 of one group with the row arbiter 30. Each group control bus 31 may include a group request line for transmitting request signals from the pixel circuits 100 of the pixel group to the row arbiter 30, and a group acknowledgement line for transmitting a group acknowledgement signal from the row arbiter 30 to the pixel circuits 100 of a group of pixel circuits 100 to be selected.

For each pixel circuit 100 detecting an event, a pixel logic circuit of the concerned pixel circuit 100 outputs an active request to the row arbiter 30 on the group request line. For transmitting the request, a request signal transmitted on the group request line has an active level.

The row arbiter 30 performs arbitration among the pending active requests output from the pixel circuits 100 of the pixel array 10. The row arbiter 30 selects a request received from a specific group of pixel circuits 100, acknowledges the request by outputting a confirmation on the group control bus 31, and transmits the corresponding group address (e.g. row number) to the column readout circuit 40. For transmitting the confirmation, the row arbiter 30 outputs an active group acknowledgement signal on the group acknowledgement line. The active group acknowledgement signal selects a group of pixel circuits 100.

In response to the confirmation, all selected pixel circuits 100 in which an event has been detected, apply the event data on the respective event data bus 41. Each event data bus 41 may be connected to some or all pixel circuits 100 of a same pixel column, or to all pixel circuits 100 of more than one pixel column.

The event data bus 41 may include a common data line for transmitting the ON events and the OFF events by different signal levels or in a time multiplex scheme. In the illustrated embodiment, the event data bus 41 includes a first data line 42 for transmitting the ON events and a second data line 43 for transmitting the OFF events. For transmitting an ON event, an ON event signal transmitted on the first data line 42 has an active level. For transmitting an OFF event, an OFF event signal transmitted on the second data line 43 has an active level.

The column readout circuit 40 receives the event data from all pixel circuits 100 of the selected pixel group via the event data bus 41, and the group address(es) of the selected pixel group from which the received event data originates from the row arbiter 30. From the group address and identifiers of the event data buses 41 transmitting event data, the column readout circuit 40 compiles a digital address event representation AER for each event. The AER includes the group address, a column address derived from the identifiers of the event data busses transmitting events, the event data, and, if applicable, a time stamp. The column readout circuit 40 outputs the AERs to the signal processing unit 60.

The solid stage imaging device 90 in FIG. 3 is configured for asynchronous, event-triggered readout. Each pixel circuit 100 that detects an event indicates the event by outputting a group request signal on a group request line of a group control bus 31 to the row arbiter 30 and a column request signal on a column interface bus 46 to a column arbiter 45. In the row arbiter 30 and the column arbiter 45, the request signals trigger the compilation of event information. The event information includes a pixel address identifying the position of the pixel circuit 100 in the pixel array 10, the sign of the change in light intensity, and a time stamp. The row arbiter 30 and the column arbiter 45 output the event information to the signal processing unit 60 and confirm to the pixel circuit 100 reception of the event. Upon receiving the confirmation, the event in the pixel circuit 100 is cleared and the pixel circuit 100 is reset.

The sensor control circuit 50 of FIG. 2 and FIG. 3 may control a timing of changing analog voltage signals in the voltage source circuit 20, a selection of voltage levels output by the voltage source circuit 20 according to internal states and/or user settings, and/or a communication between the column readout circuit 40 and the signal processing unit 60 of FIG. 2 or between the row arbiter 30, the column arbiter 45 and the signal processing unit 60 of FIG. 3 as indicated by the dashed line.

The signal processing unit 60 receives the AERs. The signal processing unit 60 may execute signal processing such as image recognition processing based on the received AERs. The signal processing unit 60 may output processed image data to the storage unit 92 of FIG. 1 and/or through a wired or wireless electronic interface.

Solid-state imaging devices 90 as described with reference to FIG. 2 and FIG. 3 can be provided as, for example, stacked contact image sensors (CIS) formed by stacking a plurality of semiconductor chips. As an example, the solid-state imaging device 90 a can be formed by a two-layer structure in which semiconductor chips are stacked in two layers.

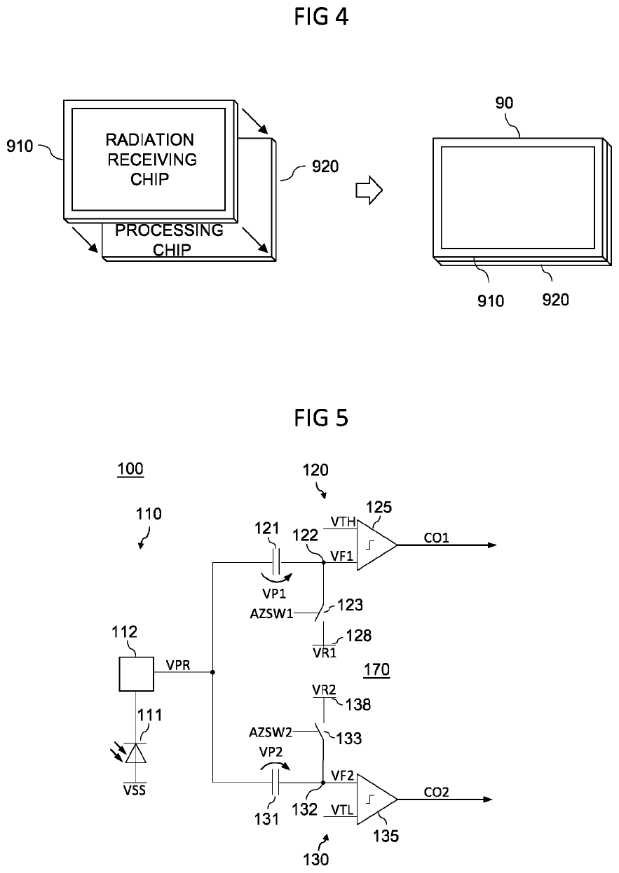

FIG. 4 is a diagram illustrating an example in which the solid-state imaging device 90 of FIG. 2 or FIG. 3 is formed by a stacked CIS having a two-layer structure with a radiation receiving chip 910 and a processing chip 920. The radiation receiving chip 910 includes at least the photoelectric conversion element., For example, the radiation receiving chip 910 may include only the photoelectric conversion element, or a part of the radiation sensitive circuit including the photoelectric conversion element and one or more transistors, or the complete radiation sensitive circuit, or the complete radiation sensitive circuit and further elements of the pixel circuits. The processing chip 920 includes the further elements of the pixel circuits 100, e.g., the event detection circuit and the pixel logic circuit. As illustrated on the right-hand side of FIG. 4, the solid-state imaging device 90 is formed as one sensor by bonding the first-layer semiconductor chip and the second-layer semiconductor chip while electrically bringing contact pads on the radiation receiving chip 910 in contact with corresponding contact pads on the processing chip 920.

FIG. 5 shows a pixel circuit 100 including a radiation sensitive circuit 110. The radiation sensitive circuit 110 converts a change of incident radiation into a pixel voltage signal VPR, wherein the pixel voltage signal VPR increases with increasing radiation intensity. A first capacitive element 121 receives the pixel voltage signal VPR at a first electrode. A second capacitive element 131 receives the pixel voltage signal VPR at a first electrode simultaneously with the first capacitive element 121. A first comparator circuit 125 compares a first resettable voltage at a second electrode of the first capacitive element 121 with a first threshold voltage VTH. A second comparator circuit 135 compares a second resettable voltage at a second electrode of the second capacitive element 121 with a second threshold voltage VTL.

The radiation sensitive circuit 110 includes a photoelectric conversion element 111 and a photoreceptor circuit 112. The photoelectric conversion element 111 may include or consist of a photodiode which by means of the photoelectric effect converts electromagnetic radiation incident on a detection surface of the pixel circuit 100 into a photodetector current. The electromagnetic radiation may include visible light, infrared radiation and/or ultraviolet radiation. The amplitude of the photodetector current corresponds to the intensity of the incident electromagnetic radiation, wherein in the intensity range of interest the detector current may increase approximately linearly with increasing intensity of the detected electromagnetic radiation.

The photoreceptor circuit 112 converts the photodetector current into the pixel voltage signal VPR. The voltage of the pixel voltage signal VPR is a function of the photodetector current, wherein in the voltage range of interest the voltage amplitude of the pixel voltage signal VPR continuously increases with continuously increasing photodetector current. For example, the voltage of the pixel voltage signal VPR increases with the photodetector current logarithmically.

The first capacitive element 121 and the first comparator circuit 125 form parts of a first event detection circuit 120. The second capacitive element 131 and the second comparator circuit 135 form parts of a second event detection circuit 130. The first capacitive element 121 receives the pixel voltage signal VPR at a first electrode. Simultaneously, the second capacitive element 131 receives the pixel voltage signal VPR at a first electrode.

The second electrode of the first capacitive element 121 forms a first floating differentiation node 122. A first floating voltage VF1 on the first differentiation node 122 is resettable and can be reset to a predefined first reference potential VRI in an autozero period. Directly after reset, a first capacitor voltage VP1 across the first capacitive element 121 is equal to a voltage difference between the pixel voltage signal VPR directly after reset and the first reference potential VR1. When after reset the first differentiation node 122 floats, the first capacitor voltage VP1 remains constant and the first floating voltage VF1 follows changes of the pixel voltage signal VPR for a detection period.

During the detection period, the pixel circuit 100 is in a detection mode and an instantaneous value of the first floating voltage VF1 is proportional to a difference between the instantaneous voltage level of the pixel voltage signal VPR and the voltage level of the pixel voltage signal VPR directly after the reset. The first floating voltage VF1 at the first differentiation node 122 is a function of a change in detected radiation intensity. The change in radiation intensity is the difference in radiation intensity between the current time and directly after reset.

The first floating voltage VF1 is applied to a first input of the first comparator circuit 125. A first threshold voltage VTH is defined by a voltage applied to a second input of the first comparator circuit 125. The first comparator circuit 125 compares the first floating voltage VF1 with the first threshold voltage VTH and outputs an active first comparator output signal CO1 only when the first floating voltage VF1 exceeds the first threshold voltage VTH. An active level of the first comparator output signal CO1 can be a digital high level or a digital low level.

Accordingly, the second electrode of the second capacitive element 131 forms a second floating differentiation node 132. A second floating voltage VF2 on the second differentiation node 132 can be reset to a predefined second reference potential VR2 in the autozero period. Directly after reset, a second capacitor voltage VP2 across the second capacitive element 131 is equal to a voltage difference between the pixel voltage signal VPR directly after reset and the second reference potential VR2. When after reset the second differentiation node 132 floats, the second capacitor voltage VP2 remains constant and the second floating voltage VF2 follows changes of the pixel voltage signal VPR for a detection period.

During the detection period, an instantaneous value of the second floating voltage VF2 is proportional to a difference between the instantaneous voltage level of the pixel voltage signal VPR and the voltage level of the pixel voltage signal VPR directly after reset. The second floating voltage VF2 at the second differentiation node 132 is a function of the change in radiation intensity between the current time and directly after reset.

The second floating voltage VF2 is applied to a first input of the second comparator circuit 135. A second threshold voltage VTL is defined by a voltage applied to a second input of the second comparator circuit 135. The second comparator circuit 135 compares the second floating voltage VF2 with the second threshold voltage VTL and outputs an active second comparator output signal CO2 only when the second floating voltage VF2 falls below the second threshold voltage VTL. An active level of the second comparator output signal CO2 can be a digital high level or a digital low level.

Since the first comparator circuit 125 and the second comparator circuit 135 can simultaneously compare floating voltages VF1, VF2 derived from the same pixel voltage signal VPR, the pixel circuit 100 allows continuous detection and high temporal resolution. The high gain across the first comparator circuit 125 and the high gain across the second comparator circuit 135 expand the range of contrast sensitivity and reduce the effects of pixel-to-pixel threshold voltage differences.

The first capacitive element 121 and the second capacitive element 131 receive the pixel voltage signal VPR at the same time at least during the detection period.

The first electrode of the first capacitive element 121 and the first electrode of the second capacitive element 131 can be electrically connected through a low resistive connection at least in a detection period. A direct low electric connection between the first electrode of the first capacitive element 121 and the first electrode of the second capacitive element 131 can be a permanent ohmic connection without pn junctions. The first electrode of the first capacitive element 121 and the first electrode of the second capacitive element 131 may be electrically connected with each other and an output of the radiation sensitive circuit 110 through a permanent low resistive connection for the complete detection period and for the complete autozero period. Alternatively, the first electrode of the first capacitive element 121 and the first electrode of the second capacitive element 131 can be connected to each other and/or an output of the radiation sensitive circuit 110 through switched connections during the detection period and can be separated from each other and/or from the output of the radiation sensitive circuit 110 outside the detection period.

FIG. 5 shows conductor lines directly connecting the output of the radiation sensitive circuit 110 with the first electrode of the first capacitive element 121, and with the first electrode of the second capacitive element 131. Alternatively, one or more electronic switches may be electrically connected between the output of the radiation sensitive circuit 110 and the first electrode of the first capacitive element 121, between the output of the radiation sensitive circuit 110 and the first electrode of the second capacitive element 131, and/or between the first electrode of the first capacitive element 121 and the first electrode of the second capacitive element 131.

The pixel circuit 100 further includes a reset portion 170. In an autozero period, the reset portion 170 connects the second electrode of the first capacitive element 121 with a first reference node 128 and the second electrode of the second capacitive element 131 with a second reference node 138.

In the autozero period the pixel circuit 100 is in an autozero mode. In the autozero mode the pixel circuit 100 resets the floating voltages VF1, VF2 at the first and second differentiation nodes 122, 132. Outside the autozero period, the reset portion 170 disconnects the second electrode of the first capacitive element 121 from the first reference node 128 and disconnects the second electrode of the second capacitive element 131 from the second reference node 138. The reset portion 170 allows to reset the potential at the first differentiation node 122 between the second electrode of the first capacitive element 121 and the first input of the first comparator circuit 125 and reset the potential at the second differentiation node 132 between the second electrode of the second capacitive element 131 and the first input of the second comparator circuit 135. The first differentiation node 122 and the second differentiation node 132 can be reset to different voltages simultaneously.

The reset portion 170 resets the first floating voltage VF1 on the first differentiation node 122 to a predefined first reference potential VR1 in the autozero period, and the second floating voltage VF2 on the second differentiation node 132 to a predefined second reference potential VR2 in the autozero period. In a detection period following the reset, the first floating voltage VF1 and the second floating voltage VF2 follow a change of the pixel voltage signal VPR.

The pixel circuit 100 of FIG. 5 includes a first reset FET 123 with a controlled path between the second electrode of the first capacitive element 121 and the first reference node 128. The pixel circuit 100 further includes a second reset FET 133 with a controlled path between the second electrode of the second capacitive element 131 and the second reference node 138.

A first autozero switch signal AZSW1 is applied to a gate of the first reset FET 123. The first autozero switch signal AZSW1 changes between an active level and an inactive level. An active first autozero switch signal AZSW1 turns on the first reset FET 123 in the autozero period. An inactive first autozero switch signal AZSW1 turns off the first reset FET 123 at least outside the autozero period, e.g., for the detection period. The first reset FET 123 may be an n channel FET (nFET), wherein an active level of the first autozero switch signal AZSW1 is the digital high level. Alternatively, the first reset FET 123 may be a pFET, wherein an active level of the first autozero switch signal AZSW1 is the digital low level.

A second autozero switch signal AZSW2 is applied to a gate of the second reset FET 133. The second autozero switch signal AZSW2 changes between an active level (active autozero switch signal) and an inactive level (inactive autozero switch signal). An active second autozero switch signal AZSW2 turns on the second reset FET 133 in the autozero period. An inactive second autozero switch signal AZSW2 turns off the second reset FET 133 at least for the detection period. The second reset FET 133 may be an nFET, wherein an active level of the second autozero switch signal AZSW2 is the digital high level. Alternatively, the second reset FET 133 may be a p channel FET (pFET), wherein an active level of the second autozero switch signal AZSW2 is the digital low level.

The first and second autozero switch signals AZSW1, AZSW2 may be synchronous in-phase signals or synchronous complementary signals. For example, a common autozero switch signal AZSW is applied to the gates of both the first reset FET 123 and the second reset FET 133.

The first and second autozero switch signals AZSW1, AZSW2 may be generated in the pixel circuit 100 or may be generated outside the pixel circuit 100, e.g., in the voltage source circuit 20 of FIG. 2 and FIG. 3 and supplied to a group of pixel circuits 100 simultaneously.

The first reference node 128 may be a low impedance node and the second reference node 138 may be a low impedance node. The first reference node 128 and/or the second reference node 138 may be conductor lines with fixed or switchable potentials.

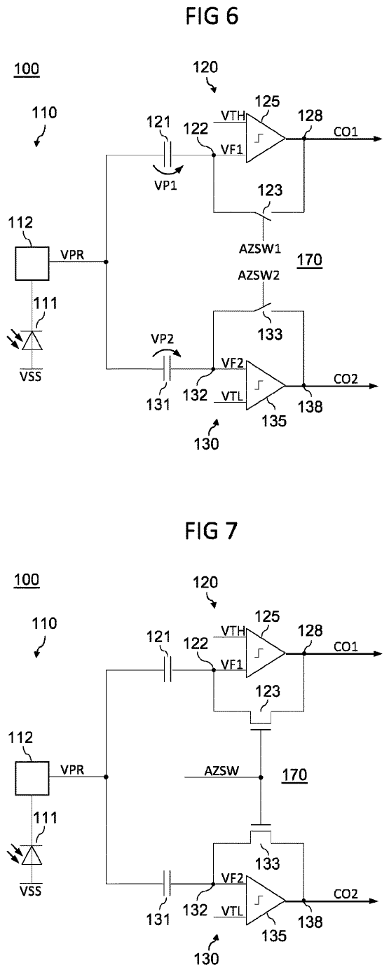

FIG. 6 shows a pixel circuit 100, in which the first reference node 128 is in an output path of the first comparator circuit 125 and the second reference node 138 is in an output path of the second comparator circuit 135.

In the illustrated embodiment, the first reference node 128 is the node between an output of the first comparator circuit 125 (first comparator output) and a circuit element directly connected to the first comparator output. Alternatively, at least one circuit element, e.g., an electronic switch may be electrically connected between the first comparator output and the first reference node 128.

The second reference node 138 can be the node between an output of the second comparator circuit 135 (second comparator output) and a circuit element directly connected to the second comparator output. Alternatively, at least one circuit element, e.g., an electronic switch may be electrically connected between the second comparator output and the second reference node 138.

By resetting, before each detection period, the potential of the first differentiation node 122 to a potential in the output path of the first comparator circuit 125, the effects of manufacturing-related differences of an offset voltage at the input stage of the first comparator circuit 125 can be at least partly compensated. The same applies to the second comparator circuit 135.

In FIG. 6, the reset portion 170 includes a first reset FET 123 and a second reset FET 133. The first reset FET 123 is connected between the first differentiation node 122 at the first input of the first comparator circuit 125 and the first reference node 128 at the first comparator output. The second reset FET 133 is connected between the second differentiation node 132 at the first input of the second comparator circuit 135 and the second reference node 138 at the second comparator output.

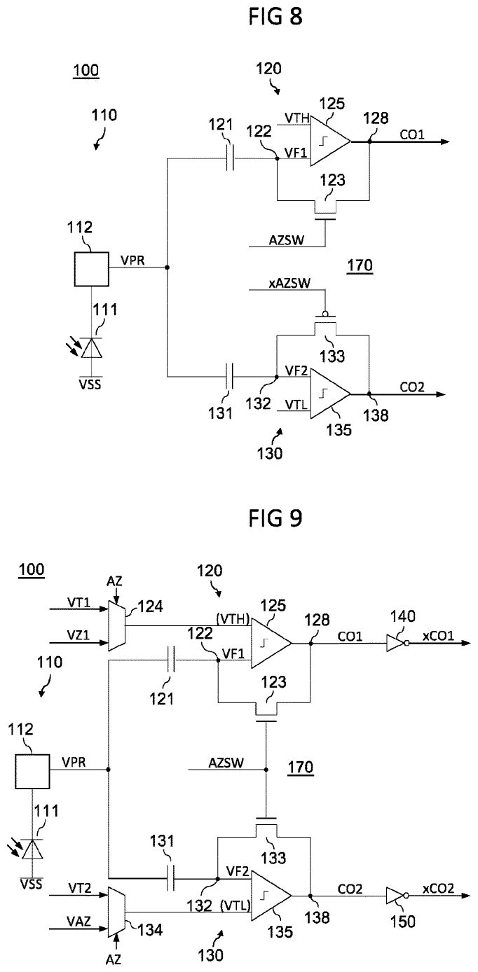

In FIG. 7, the first reset FET 123 and the second reset FET 133 have a same channel type. A single autozero switch signal AZSW simultaneously controls the first reset FET 123 and the second reset FET 133.

In the illustrated embodiment, the first reset FET 123 and the second reset FET 133 are nFETs, the active voltage level is the digital high level, and the inactive voltage level is the digital low level.

The common autozero switch signal AZSW is transmitted on a common autozero switch conductor that is electrically connected to a gate of the first reset FET 123 and the gate of the second reset FET 133.

The common autozero switch signal AZSW changes between an active level and an inactive level. An active common autozero switch signal AZSW turns on the first reset FET 123 and the second reset FET 133 in the autozero period. An inactive common autozero switch signal AZSW turns off the first reset FET 123 and the second reset FET 133 outside the autozero period, e.g., for the detection period. The first reset FET 123 and the second reset FET 133 may be nFETs, wherein an active level of the common autozero switch signal AZSW is the digital high level. Alternatively, the first reset FET 123 and the second reset FET 133 may be pFETs, wherein an active level of the common autozero switch signal AZSW is the digital low level.

The common autozero switch signal AZSW can be generated in the pixel circuit 100 or may be generated outside the pixel circuit 100, e.g., in the voltage source circuits 20 of FIG. 2 and FIG. 3 and supplied to a group of pixel circuits 100 simultaneously.

In FIG. 8, the first reset FET 123 and the second reset FET 133 have complementary channel types, an autozero switch signal AZSW is configured to control the first reset FET 123, and a complementary autozero switch signal xAZSW is configured to control the second reset FET 133.

The autozero switch signal AZSW and the complementary autozero switch signal xAZSW have complementary active signal levels. The autozero switch signal AZSW and the complementary autozero switch signal xAZSW simultaneously change from the inactive level to the active level and simultaneously change from the active level to the inactive level.

FIG. 9 refers to a pixel circuit 100 that further includes a first multiplexer 124 and a second multiplexer 134. The first multiplexer 124 applies a first threshold defining voltage VT1 defining the first threshold voltage VTH to the first comparator circuit 125 in a detection period and a first autozero voltage VZ1 to the first comparator circuit 125 in an autozero period. The second multiplexer 134 applies a second threshold defining voltage VT2 defining the second threshold voltage VTL to the second comparator circuit 135 in the detection period and a second autozero voltage VZ2 to the second comparator circuit 135 in the autozero period.

In FIG. 9, the first threshold defining voltage VT1 is applied to a first data input of the first multiplexer 124. Depending on the structure of the first comparator circuit 125, the first threshold defining voltage VTI may be equal to the first threshold voltage VTH or may be selected such that the first threshold voltage VTH is generated as an internal voltage of the first comparator circuit 125. The first autozero voltage VZ1 is applied to a second data input of the first multiplexer 124. An output of the first multiplexer 124 (first multiplexer output) is electrically connected with the second input of the first comparator circuit 125.

An autozero signal AZ is applied to a select input of the first multiplexer 124. The autozero signal AZ changes between an active level (active autozero signal AZ) and an inactive level (inactive autozero signal). The autozero signal AZ is active in the autozero period and inactive outside the autozero period, e.g., in the detection period. The active autozero signal AZ selects the first autozero voltage VZ1 for output at the first multiplexer output in the autozero period. The inactive autozero signal AZ selects the first threshold defining voltage VT1 for output at the first multiplexer output in the detection period.

The second threshold defining voltage VT2 is applied to a first data input of the second multiplexer 134. Depending on the structure of the second comparator circuit 135, the second threshold defining voltage VT2 may be equal to the second threshold voltage VTL or may be selected such that the second threshold voltage VTL is generated as an internal voltage of the second comparator circuit 135. The second autozero voltage VZ2 is applied to a second data input of the second multiplexer 134. An output of the second multiplexer 134 (second multiplexer output) is electrically connected with the second input of the second comparator circuit 135.

The autozero signal AZ is applied to a select input of the second multiplexer 134. The active autozero signal AZ selects the second autozero voltage VZ2 for output at the second multiplexer output. The inactive autozero signal AZ selects the second threshold defining voltage VT2 for output at the second multiplexer output.

The first autozero voltage VZ1 and the second autozero voltage VZ2 can be equal.

Alternatively, the first autozero voltage VZ1 and the second autozero voltage VZ2 are different.

Different voltage levels for the first autozero voltage VZ1 and the second autozero voltage VZ2 allow the comparator speed and/or current consumption in both comparator branches to be tuned independently from each other.

The autozero signal AZ may be generated in the pixel circuit 100 or may be generated outside the pixel circuit 100 and supplied to a group of pixel circuits 100 simultaneously. A single autozero switch signal AZSW controls both the first reset FET 123 and the second reset FET 133. The autozero switch signal AZSW may be generated in the pixel circuit 100 or may be generated outside the pixel circuit 100 and supplied to at least a group of pixel circuits 100 simultaneously.

The first comparator output signal CO1 is applied to an input of a first inverter circuit 140 that outputs the inverted first comparator output signal xCO1. The second comparator output signal CO2 is applied to an input of a second inverter circuit 140 that outputs the inverted second comparator output signal xCO2. The first and second inverter circuits 140, 150 may decouple the outputs of the first and second event detection circuits 120, 130 from a pixel logic circuit receiving the inverted first and second comparator output signals xCO1, xCO2, for providing appropriate signal levels at inputs of the pixel logic circuit, and/or for providing appropriate signal polarities. In particular, the first and second inverter circuits 140, 150 can provide enough gain to output at least roughly digital signal levels.

The first autozero voltage VZ1, the second autozero voltage VZ2, the first threshold defining voltage VT1 and the second threshold defining voltage VT2 may be generated in the pixel circuit 100 or outside the pixel circuit 100, e.g., in the voltage source circuits 20 illustrated in FIG. 2 and FIG. 3.

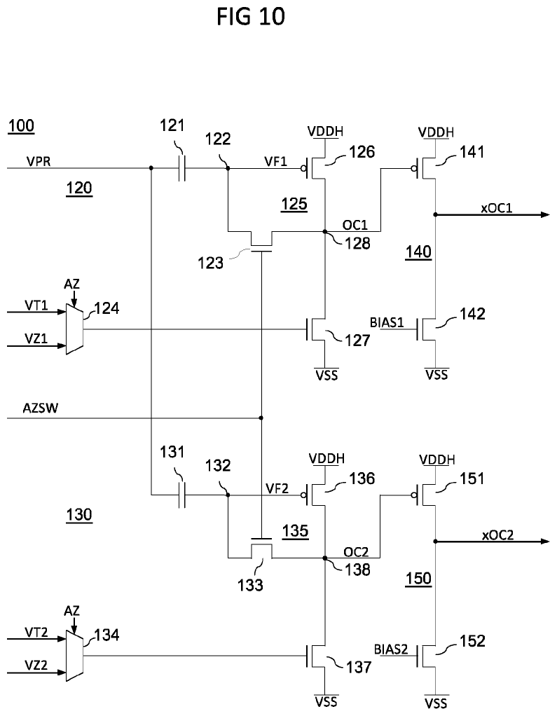

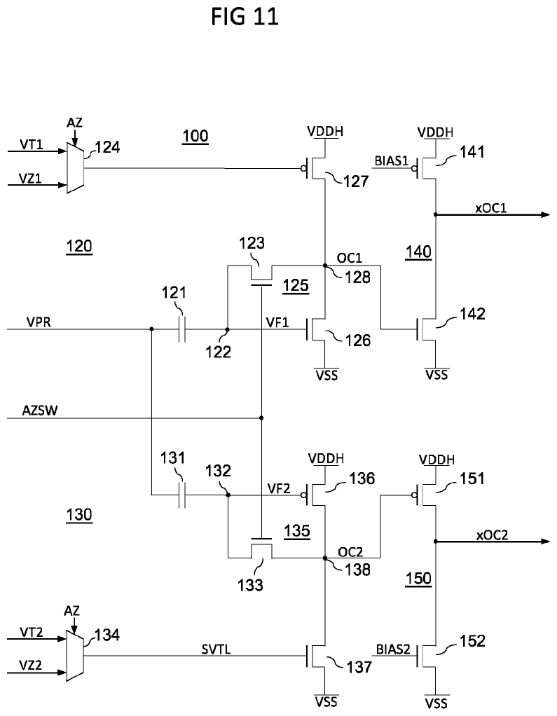

In the pixel circuits 100 of FIG. 10 and FIG. 11, the first comparator circuit 125 includes a first amplifier transistor 126 and a first load transistor 127. Controlled paths of the first amplifier transistor 126 and the first load transistor 127 are electrically connected in series between a positive pixel supply voltage VDDH and a reference potential VSS. The second electrode of the first capacitive element 121 is connected to a gate of the first amplifier transistor 126. A gate of the first load transistor 127 receives a first threshold defining voltage VT1 in a detection period. The gate of the first load transistor 127 can receive a first autozero voltage VZ1 in the autozero period.

The second comparator circuit 135 includes a second amplifier transistor 136 and a second load transistor 137. Controlled paths of the second amplifier transistor 136 and the second load transistor 137 are electrically connected in series between the positive pixel supply voltage VDDH and the reference potential VSS. The second electrode of the second capacitive element 131 is connected to a gate of the second amplifier transistor 136. A gate of the second load transistor 137 receives a second threshold defining voltage VT2 in the detection period. The gate of the second load transistor 137 can receive a second autozero voltage VZ2 in the autozero period.

The first comparator circuit 125 outputs the first comparator output signal CO1 at a network node between the controlled paths of the first amplifier transistor 126 and the first load transistor 127. The network node between the controlled paths of the first amplifier transistor 126 and the first load transistor 127 serves also as first reference node 128.

In the autozero periods, an active autozero signal AZ controls the first multiplexer 124 to output the first autozero voltage VZ1 to the gate of the first load transistor 127 and an active autozero switch signal AZSW turns on the first reset FET 123 to connect the first differentiation node 122 with the first reference node 128. The first floating voltage VF1 is set to a reset voltage defined by the first autozero voltage VZ1 and the characteristics of the first load transistor 127. Towards the end of the autozero periods, the first reset FET 123 turns off and separates the first differentiation node 122 from the first reference node 128.

In the detection periods, an inactive autozero signal AZ controls the first multiplexer 124 to output the first threshold defining voltage VT1 to the gate of the first load transistor 127. The first reset FET 123 is off and separates the first differentiation node 122 from the first reference node 128. The first differentiation node 122 floats. The first floating voltage VF1 at the gate of the first amplifier transistor 126 follows changes of the pixel voltage signal VPR with respect to the voltage level of the pixel voltage signal VPR when the first reset FET 123 turns off towards the end of the last autozero period.

The second comparator circuit 135 outputs the second comparator output signal CO2 at a network node between the controlled paths of the second amplifier transistor 136 and the second load transistor 137. The network node between the controlled paths of the second amplifier transistor 136 and the second load transistor 137 serves also as second reference node 138.

In the autozero periods, the active autozero signal AZ controls the second multiplexer 134 to output the second autozero voltage VZ2 to the gate of the second load transistor 137 and the active autozero switch signal AZSW turns on the second reset FET 133 to connect the second differentiation node 132 with the second reference node 138. The second floating voltage VF2 is set to a reset voltage defined by the second autozero voltage VZ2 and the characteristics of the second load transistor 137. Towards the end of the autozero periods, the second reset FET 133 turns off and separates the second differentiation node 132 from the second reference node 138.

In the detection periods, the inactive autozero signal AZ controls the second multiplexer 134 to output the second threshold defining voltage VT2 to the gate of the second load transistor 137. The second reset FET 133 is off and separates the second differentiation node 132 from the second reference node 138. The second differentiation node 132 floats. The second floating voltage VF2 at the gate of the second amplifier transistor 136 follows changes of the pixel voltage signal VPR with respect to the voltage level of the pixel voltage signal VPR when the second reset FET 133 turns off towards the end of the last autozero period.

In the pixel circuit 100 of FIG. 10, the first amplifier transistor 126 is a pFET. The first load transistor 127 is an nFET. The controlled path of the first load transistor 127 is connected between the controlled path of the first amplifier transistor 126 and the reference potential VSS.

In the pixel circuit 100 of FIG. 11, the first amplifier transistor 126 is an n FET. The first load transistor 127 is a pFET. The controlled path of the first load transistor 127 is connected between the positive pixel supply potential VDDH and the controlled path of the first amplifier transistor 126.

For the pixel circuit 100 of FIG. 10, the reset voltage for the first floating voltage VF1 can be selected such that directly after the autozero period and at the beginning of the detection period, the pFET used as first amplifier transistor 126 is “on” to a higher degree than the first load transistor. The first floating voltage VF1 follows each change of the pixel voltage signal VPR with reference to a voltage level of the pixel voltage signal VPR directly after reset towards the end of the autozero period. With increasing first floating voltage VF1, the first amplifier transistor 126 becomes more and more less conductive, When an increase of the pixel voltage signal VPR is high enough, then a voltage difference between the first differentiation node 122 and the first reference node 128 exceeds the threshold voltage of the first amplifier transistor 126, and the first amplifier transistor 126 turns off. The first comparator output signal OC1 can be approximated as an active low signal.

The second amplifier transistor 136 is a pFET. The second load transistor 137 is an nFET. The controlled path of the second load transistor 137 is connected between the controlled path of the second amplifier transistor 136 and the reference potential VSS.

The reset voltage for the second floating voltage VF2 can be selected such that directly after the autozero period and at the beginning of the detection period, the pFET used as second amplifier transistor 136 is rather “off” compared to the second load transistor 137, though some current may still flow through the second amplifier transistor 136. The second floating voltage VF2 follows each change of the pixel voltage signal VPR with reference to the voltage level of the pixel voltage signal VPR directly after reset towards the end of the autozero period. With decreasing second floating voltage VF2, the second amplifier transistor 136 becomes more and more conductive, When the pixel voltage signal VPR decreases to a sufficient degree, then a voltage difference between the second differentiation node 132 and the second reference node 138 falls below the threshold voltage of the second amplifier transistor 136, and the second amplifier transistor 136 turns on. The second comparator output signal OC2 can be considered as an active high signal.

A first inverter circuit 140 includes a first auxiliary inverting FET 141 and a first auxiliary load FET 142, wherein controlled paths of the first auxiliary inverting FET 141 and the first auxiliary load FET 142 are electrically connected in series between the positive pixel supply voltage VDDH and the reference potential VSS. The first inverter circuit 140 receives the first comparator output signal CO1 at the gate of the first auxiliary inverting FET 141. A first bias voltage BIAS1 is applied to the gate of the first auxiliary load FET 142. The first inverter circuit 140 outputs the inverted first comparator output signal xCO1 at an inverter output node between the controlled path of the first auxiliary inverting FET 141 and the controlled path of the first auxiliary load FET 142.

A second inverter circuit 150 includes a second auxiliary inverting FET 151 and a second auxiliary load FET 152, wherein controlled paths of the second auxiliary inverting FET 151 and the second auxiliary load FET 152 are electrically connected in series between the positive pixel supply voltage VDDH and the reference potential VSS. The second inverter circuit 150 receives the second comparator output signal CO2 at the gate of the second auxiliary inverting FET 151. A second bias voltage BIAS2 is applied to the gate of the second auxiliary load FET 152. The second inverter circuit 150 outputs the inverted second comparator output signal xCO2 at an inverter output node between the controlled path of the second auxiliary inverting FET 151 and the controlled path of the second auxiliary load FET 152.

The first bias signal BIAS1 and the second bias signal BIAS2 may be generated in the pixel circuit 100 or outside the pixel circuit 100, e.g., in the voltage source circuit 20 illustrated in FIG. 2 and FIG. 3.

In both FIG. 10 and FIG. 11, the second amplifier transistor 136 is a pFET. The second load transistor 137 is an n FET. The controlled path of the second load transistor 137 is connected between the controlled path of the second amplifier transistor 136 and the reference potential VSS.

Alternatively, the second amplifier transistor 136 can be an nFET and the second load transistor 137 a pFET, wherein the controlled path of the second load transistor 137 is connected between the positive pixel supply potential VDDH and the controlled path of the second amplifier transistor 136.

A high level of the inverted first comparator output signal xCO1 indicates that a change of the pixel voltage signal VPR exceeds the first threshold voltage VTH. The inverted first comparator output signal xCO1 represents an on-event signal ON with active high level.

A low level of the inverted second comparator output signal xCO2 indicates that a change of the pixel voltage signal VPR falls below the second threshold voltage VTL. The inverted second comparator output signal xCO2 has an active low level.

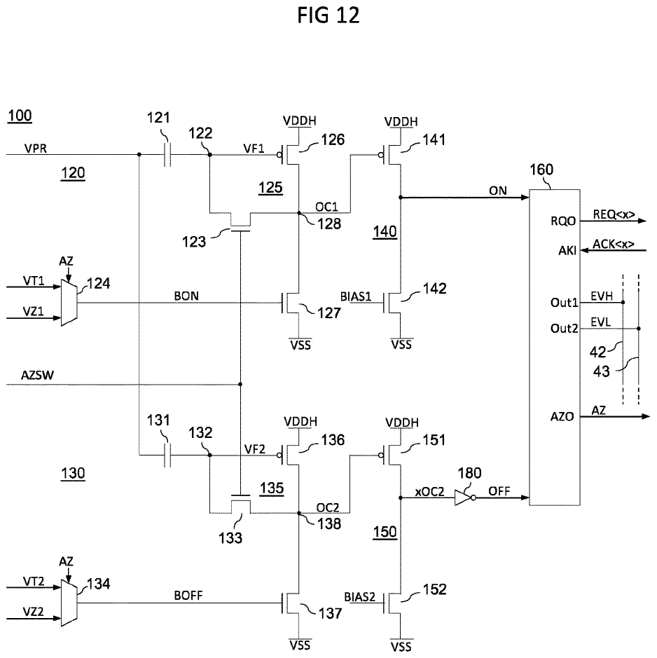

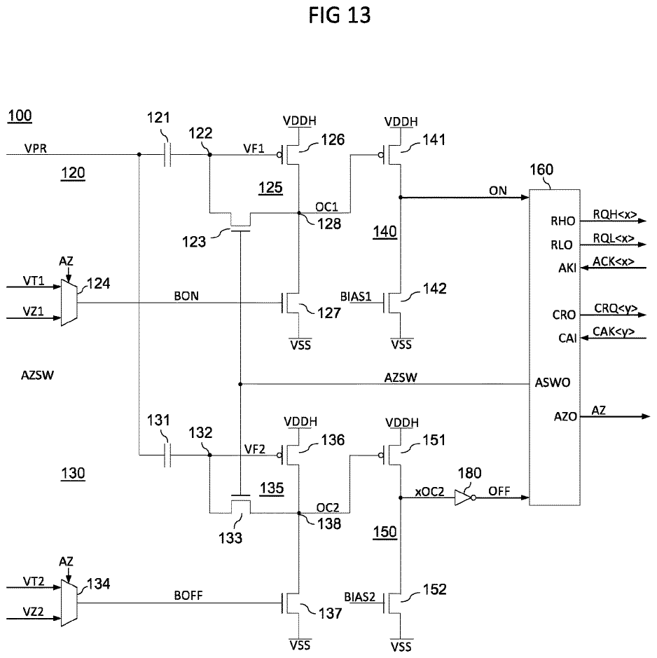

In FIG. 12 and FIG. 13, an auxiliary inverter 180 inverts the inverted second comparator output signal xCO2 to obtain an off-event signal OFF with an active high voltage level.

The pixel circuits 100 include pixel logic circuits 160 that output an active request signal REQ<x>, ROH<x>, RQL<x> in response to an active output signal CO1 of the first comparator circuit 125 and/or in response to an active output signal CO2 of the second comparator circuit 135.

FIG. 12 shows a pixel logic circuit 160 for a synchronous readout using an event data bus with a first data line 42 for transmitting the ON events and a second data line 43 for transmitting the OFF events. The pixel logit circuit 160 outputs an active group request signal REQ<x> when the first comparator circuit 125 outputs an active first comparator output signal CO1 indicating that the voltage on the first differentiation node exceeds 122 the first threshold voltage VTH or when an active second comparator output signal CO2 indicates that the voltage on the second differentiation node 132 falls below the second threshold voltage VTL.

The pixel logic circuit 160 outputs the active group request signal REQ<x> through a request signal output RQO to a request signal line. The request signal output RQO may be an open collector output or any other output type allowing a group of pixel circuits 100, e.g., the pixel circuits 100 of a pixel row to be connected to the same request signal line.

The row arbiter 30 of FIG. 2 receives the active request signals REQ<x> from different groups of pixel circuits 100, selects one of the groups of pixel circuits 100 for the next readout according to a predefined arbiter scheme, and outputs an active group acknowledgement signal ACK<x> to the group of pixel circuits 100 selected for the next readout.

In response to receiving the active group acknowledgement signal ACK<x> at an acknowledgement signal input AKI, the pixel logic circuit 160 outputs an active ON event signal EVH through a first output Out1 to the first data line 42 or an active OFF event signal EVL through a second output Out2 to the second data line 43. Further in response to receiving the active group acknowledgement signal ACK<x>, the pixel logic circuit 160 switches the group request signal REQ<x> to the inactive level and may change into the autozero mode.

FIG. 13 shows a pixel logic circuit 160 for an asynchronous, event-triggered readout using a group control bus 31 to the row arbiter 30 and a column interface bus 46 to the column arbiter 45 of FIG. 3.

The pixel logic circuit 160 outputs an active row ON request signal RQH<x> at an ON request output RHO to the row arbiter 30 in case an ON event has been detected and outputs an active row OFF request signal RQL<x> at an OFF request output RLO in case an OFF event has been detected. The ON request output RHO and the OFF request output RLO may be open collector outputs or may have any other output type allowing a plurality of pixel circuits 100 to be connected to the same row request lines.

Another embodiment (not illustrated) may use a single row event request signal REQ<x> triggered by both ON and OFF events, a single group acknowledgement signal ACK<x>, separate ON event and OFF event column request signals CRH<y>, CRL<y>, and a single shared column acknowledge signal CAK<y>.

The row arbiter 30 of FIG. 3 receives the active row ON request signal RQH<x> and the active row OFF request signals RQL<x> from different groups of pixel circuits 100, selects one of the groups of pixel circuits 100 for the next readout according to a predefined arbiter scheme, and outputs an active group acknowledgement signal ACK<x> to the group of pixel circuits 100 selected for the next readout.

In response to receiving the active group acknowledgement signal ACK<x> at an acknowledgement signal input AKI, the pixel logic circuit 160 outputs an active column request signal CRQ<y> at a column request output CRO. The column arbiter 45 of FIG. 3 receives the active column request signals CRQ<y> from the selected pixel group and compiles address event representations of the events. The address event representation identifies the pixel circuit 100 and further includes information about the type of event (ON or OFF), and a time stamp.

The column arbiter 45 may output an active column acknowledgement signal CAK<y> to the pixel circuits 100 from which the column arbiter 45 has received active column request signals CRQ<y>.

In response to receiving the active column acknowledgement signal CAK<y>, the pixel logic circuit 160 may reset the row ON request signal RQH<x>, the row OFF request signal RQL<x>, and the column request signal CRQ<y> to the inactive level and may change into the autozero mode.

FIG. 12 and FIG. 13 are non-exhaustive illustrations of signal interfaces of pixel logic circuits 160 to a row arbiter, a column signal processing unit, and a column arbiter. Other signal interfaces may use other signals for synchronous readout or for event-triggered readout.

Both in FIG. 12 and FIG. 13, the pixel logic circuit 160 controls resetting the voltage on the second electrode of the first capacitive element 121 and resetting the voltage on the second electrode of the second capacitive element 131 in an autozero period starting in response to receiving an active acknowledgement signal.

In FIG. 12, the active acknowledgement signal is the group acknowledgement signal (row acknowledgement signal) ACK<x>.

In FIG. 13, depending on the internal configuration of the pixel circuits 100, the active acknowledgement signal can be the column acknowledgement signal CAK <y> or the group acknowledgement signal (row acknowledgement signal) ACK<x>.

After resetting the voltage on the second electrode of the first capacitive element 121 and resetting the voltage on the second electrode of the second capacitive element 131, the first floating voltage VF1 and the second floating voltage VF2 follow a change of the pixel voltage signal with reference to the voltage level of the pixel voltage signal directly after reset towards the end of the autozero period. In particular, the first floating voltage VF1 and the second voltage VF2 are a continuous function of a change in detected radiation intensity.

The pixel logic circuit 160 can output an active autozero signal AZ for an autozero period in response to receiving an active acknowledgement signal ACK<x>, CAK<y>.

The pixel logic circuit 160 outputs an active autozero signal AZ at an autozero output AZO in response to receiving an acknowledgement signal indicating that the previously detected event has been read out. The pertinent acknowledgement signal may be the group acknowledgement signal ACK<x> or the column acknowledgement signal CAK<y>.

The active autozero signal AZ controls the first and second multiplexers 124, 134 to apply the first and second autozero voltages VZ1, VZ2 to the gates of the load transistors 127, 137 of the first and second comparator circuits 125, 135. In addition, the active autozero signal AZ can control passing the autozero switch signal AZSW to the first and second reset FETs 123, 133.

In FIG. 13, the pixel logic circuit 160 outputs an autozero switch signal AZSW at an autozero switch output ASWO. The autozero switch signal AZSW turns off the first and second reset FETs 123, 133 sufficiently slowly to avoid significant charge injection into the floating differentiation nodes 122, 132.

Alternatively, the autozero switch signal may be generated outside the pixel circuit 100, e.g., in the voltage source circuit 20 illustrated in FIG. 2 and FIG. 3. In such a case, the active autozero signal AZ may be used to gate or connect the outside autozero switch signal AZSW to the gates of the first and second reset FETs 123, 133 to avoid that pixel circuits 100 without an event are reset: When the autozero signal AZ is active, the autozero switch signal AZSW is connected to the gates of the first and second reset FETs 123, 133. When the autozero signal AZ is inactive, the autozero switch signal AZSW is disconnected from the gates of the first and second reset FETs 123, 133, and the gates of the first and second reset FETs 123, 133 are connected to a suitable potential turning off the first and second reset FETs 123, 133. For example, a low voltage such as the reference potential VSS is applied to the gates of the first and second reset FETs 123, 133, if the first and second reset FETs are nFETs.

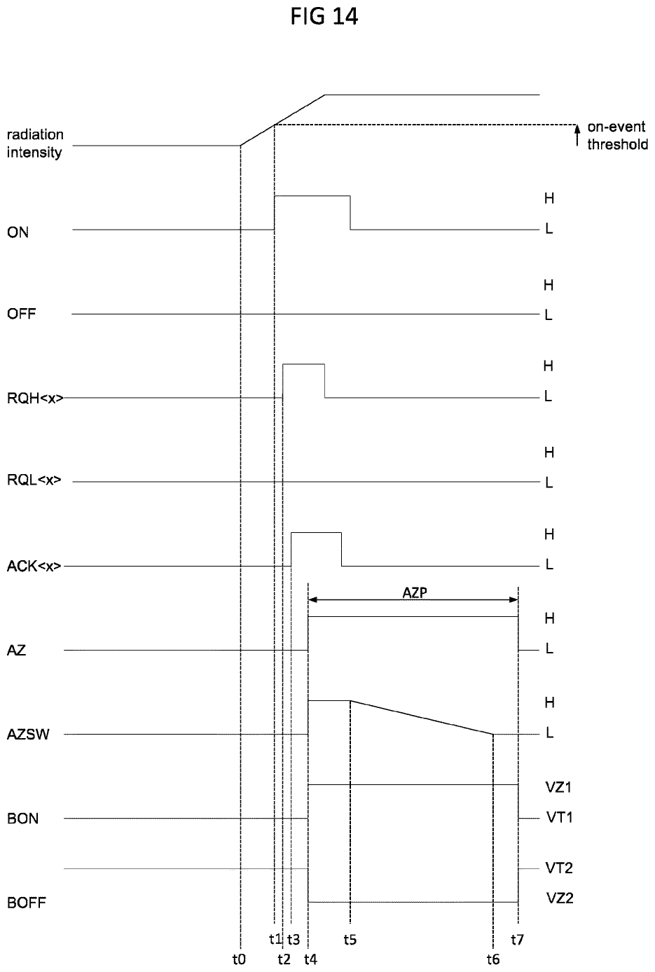

FIG. 14 shows a time diagram for some of the signals in FIG. 13. For each illustrated electric signal, the active level is the high level. The first multiplexer 124 outputs the first switched signal BON. The second multiplexer 134 outputs the second switched signal BOFF.

At the beginning, the pixel circuit 100 is in the detection mode. The autozero signal AZ is inactive. The first multiplexer 124 outputs the first threshold defining voltage VTI as the first switched signal BON. The second multiplexer 134 outputs the second threshold defining voltage VT2 as the second switched signal BOFF.

At t=t0, the intensity of radiation incident on a radiation-sensitive region of the photoelectric conversion element 111 begins to increase. The signal levels of the pixel voltage signal VPR, the first floating voltage VF1, and the second floating voltage VF2 increase accordingly.

At t=t1, the radiation intensity exceeds an effective on-event threshold at which the first floating voltage VF1 is high enough to turn off the first amplifier transistor 126. The first comparator output signal OC1 changes to the active low level and the on-event signal ON, which is the inverted first comparator output signal OC1, changes to the active high level.

At t=t2 shortly after t=t1, the pixel logic circuit 160 outputs an active row ON request signal RQH<x> to the row arbiter. When the row arbiter selects the pixel group including the requesting pixel circuit 100 for the next readout, the row arbiter sends a group acknowledgement signal ACK<x> to the pixel group including the requesting pixel circuit 100.

The pixel circuit 100 receives the group acknowledgement signal ACK<x> at t=t3. In response to receiving the row acknowledgement signal ACK<x>, the pixel circuit 100 may proceed with outputting the event data, e.g., by outputting the on-event signal EVH to a data signal line or by outputting a column request signal to a column arbiter.

At t=t4, an autozero period AZP starts with the pixel circuit 100 outputting an active autozero signal AZ with active high level and an active autozero switch signal AZSW with active high level. The active autozero switch signal AZSW turns on the first reset FET 123 and the second reset FET 133. The active autozero signal AZ controls the first multiplexer 124 to output the first autozero voltage VZ1 as the first switched signal BON and controls the second multiplexer 134 to output the second autozero voltage VZ2 as the second switched signal BOFF. The first and second floating voltages VF1, VF2 are reset to the respective reset voltages. The first comparator output signal OC1 returns to the high level and the on-event signal ON to the inactive low level. The row ON request signal RQH<x> returns to the low level. The row arbiter resets the row acknowledgment signal ACK<x> to the low level.

At t=t5 the autozero switch signal AZSW begins to fall and turns off the first and second reset FETs 123, 133 sufficiently slowly. At t=t6 the autozero switch signal AZSW reaches the signal low level. The first and second floating voltages VF1, VF2 are reset between t=t4 and t=t56. The slow ramp of the autozero switch signal AZSW prevents subsequent alterations of the first and second floating voltages VF1, VF2, when the first and second reset FETs 123, 133 turn off.

At t=t7, the autozero period AZP ends with the pixel circuit 100 switching the autozero signal AZ to the inactive low level. The pixel circuit 100 changes to a detection mode with inactive autozero signal AZ. The first multiplexer 124 outputs the first threshold defining voltage VT1 as the first switched signal BON. The second multiplexer 134 outputs the second threshold defining voltage VT2 as the second switched signal BOFF. The first and second reset FETs 123, 126 are off. In the detection mode, changes of the first and second floating voltages VF1, VF2 represent changes of the detected radiation intensity with respect to a radiation intensity when the first and second reset FETs are turned off between t=t5 and t=t6.

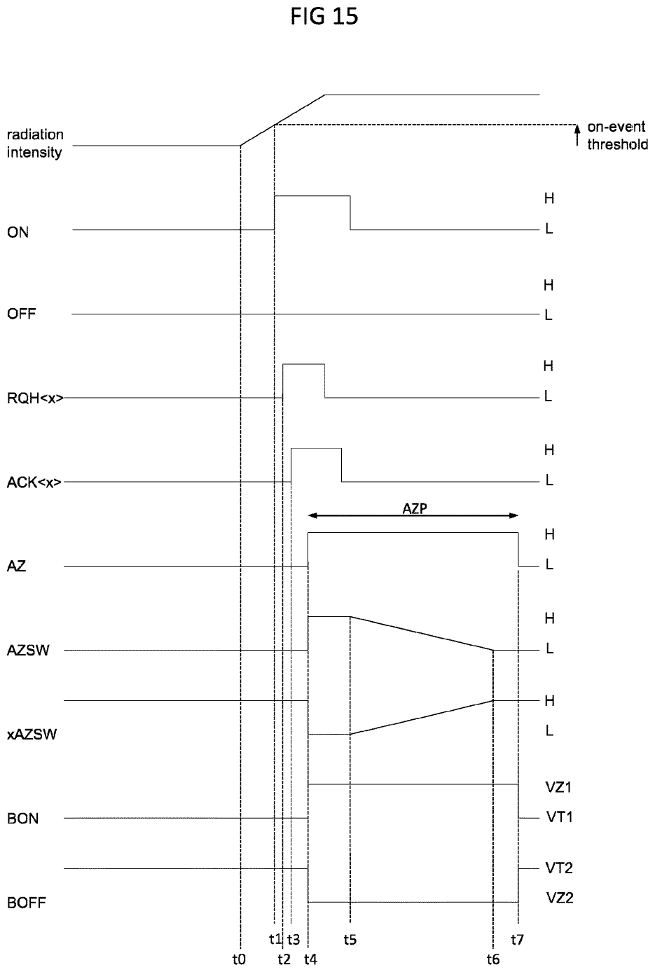

FIG. 15 shows a time diagram for electric signals in a pixel circuit 100 using complementary autozero switch signals AZSW and xAZSW as illustrated in FIG. 8.

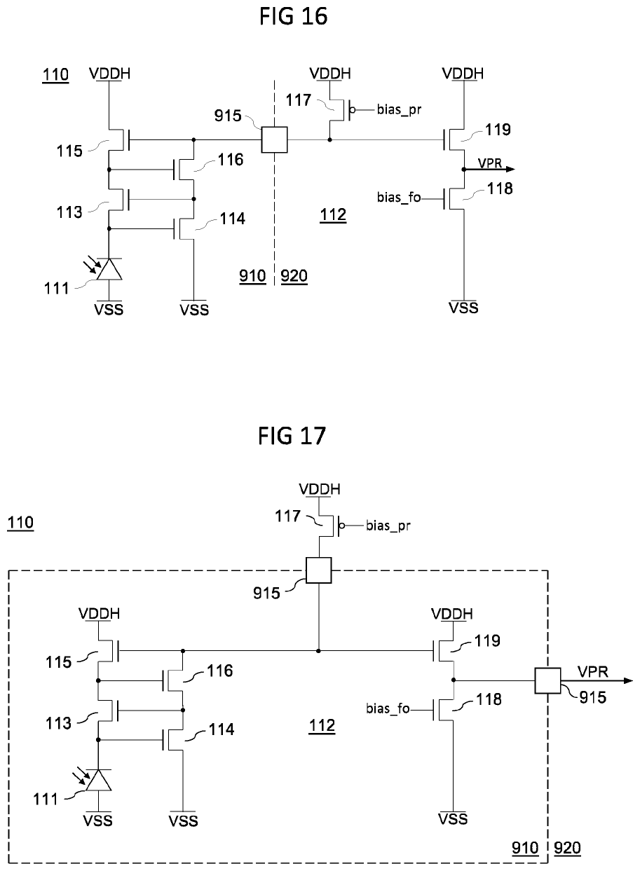

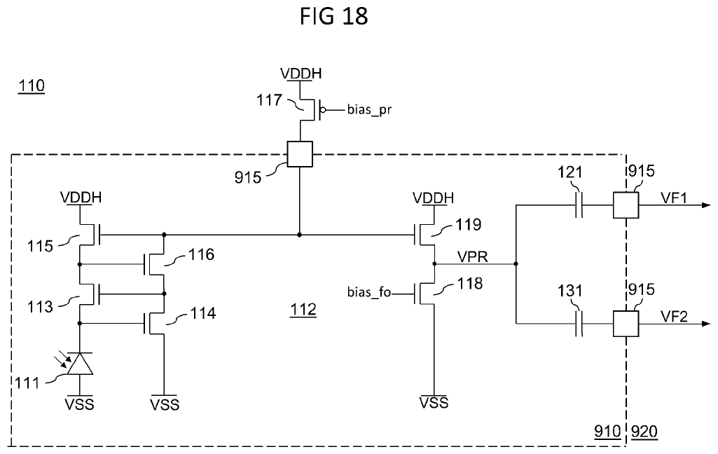

FIG. 16, FIG. 17, and FIG. 18 show configuration examples of a radiation sensitive circuit 110 including a photoelectric conversion element 111, a multiple transistor feedback logarithmic amplifier circuit (LAC) and a source follower 118, 119.

The anode of the photoelectric conversion element 111 is electrically connected to the reference potential VSS. The LAC includes a first amplifier NFET 115 and a second amplifier NFET 113 electrically connected in series between a positive pixel supply voltage VDDH and the cathode of the photoelectric conversion element 111. A pull-up PFET (pFET) 117 with constantly biased gate, a third amplifier NFET 116 and fourth amplifier NFET 114 are electrically connected in series between the positive pixel supply potential VDDH and the reference potential VSS. The gate of the fourth amplifier NFET 114 is connected to the cathode of the photoelectric conversion element 111. The gate of the second amplifier NFET 113 is connected to a network node between the third amplifier NFET 116 and the fourth amplifier NFET 114. The gate of the third amplifier NFET 116 is connected to a network node between the first amplifier NFET 115 and the second amplifier NFET 113. The gate of the first amplifier NFET 115 is connected to a LAC output node between the pull-up PFET 117 and the third amplifier NFET 116.

The source follower includes a source follower NFET 119 and a load NFET 118 with constantly biased gate electrically connected in series between the positive pixel supply potential VDDH and the reference potential VSS. The LAC output node is electrically connected to the gate of the source follower NFET 119. The source follower outputs the pixel voltage signal VPR. The source follower forms a near-unity-gain voltage buffer that isolates the LAC from the first and second event detection circuits 120, 130.

Other examples of the radiation sensitive circuit 110 may be based on a more basic configuration of a logarithmic amplifier with one inverting amplifier and one feedback element that is connected between an input and an output of the inverting amplifier. The inverting amplifier ensures that a voltage across the photoelectric conversion element 111 is approximately constant. The pixel voltage signal VPR shows a logarithmic dependence on the photocurrent of the photoelectric conversion element 111.

As mentioned with reference to FIG. 4, an image sensor may include a radiation receiving chip 910 and a processing chip 920.

In FIG. 16, the radiation receiving chip 910 includes the photoelectric conversion element 111 and the NFETs 113, 114, 115, 116 of the logarithmic amplifier. The processing chip 920 includes the pull-up PFET 117, the source follower with the source follower NFET 119 and the load NFET 118, the first and second event detection circuits and the pixel logic circuit. One through contact via 915 per pixel circuit passes the LAC output signal from the radiation receiving chip 910 to the processing chip 920.

In FIG. 17, the radiation receiving chip 910 includes the photoelectric conversion element 111 and the NFETs 113, 114, 115, 116 of the logarithmic amplifier and the source follower with the source follower NFET 119 and the load NFET 118. The processing chip 920 includes the pull-up PFET 117, the first and second event detection circuits and the pixel logic circuit. A first through contact via 915 is part of an electric connection between the pull-p PFET 117 in the processing chip 920 and the LAC output in the radiation receiving chip 910. A second through contact via 915 passes the pixel voltage signal VPR from the radiation receiving chip 910 to the processing chip 920.

In FIG. 18, the radiation receiving chip 910 includes the photoelectric conversion element 111 and the NFETs 113, 114, 115, 116 of the logarithmic amplifier, the source follower with the source follower NFET 119, and the load NFET 118, the first capacitive element 121, and the second capacitive element 131. The processing chip 920 includes the rest of the pixel circuit. A first through contact via 915 is part of an ohmic, low-resistive connection between the pull-p PFET 117 in the processing chip 920 and the LAC output in the radiation receiving chip 910. A second through contact via 915 is part of a low-resistive, ohmic connection between the second electrode of the first capacitive element 121 in the radiation receiving chip 910 and the first input of the first comparator circuit in the processing chip 920. A third through contact via 915 is part of a low-resistive, ohmic connection between the second electrode of the second capacitive element 131 in the radiation receiving chip 910 and the first input of the second comparator circuit in the processing chip 920.

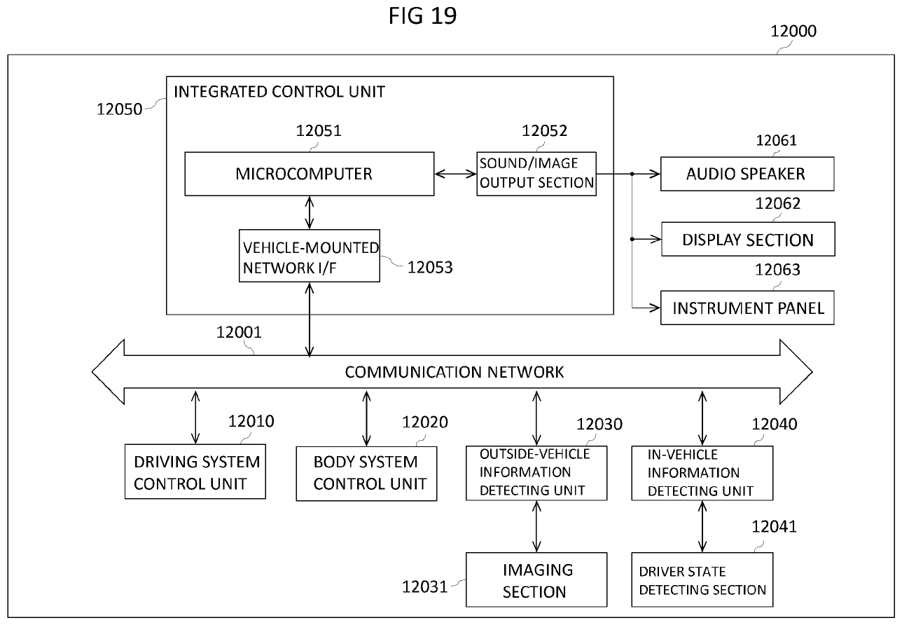

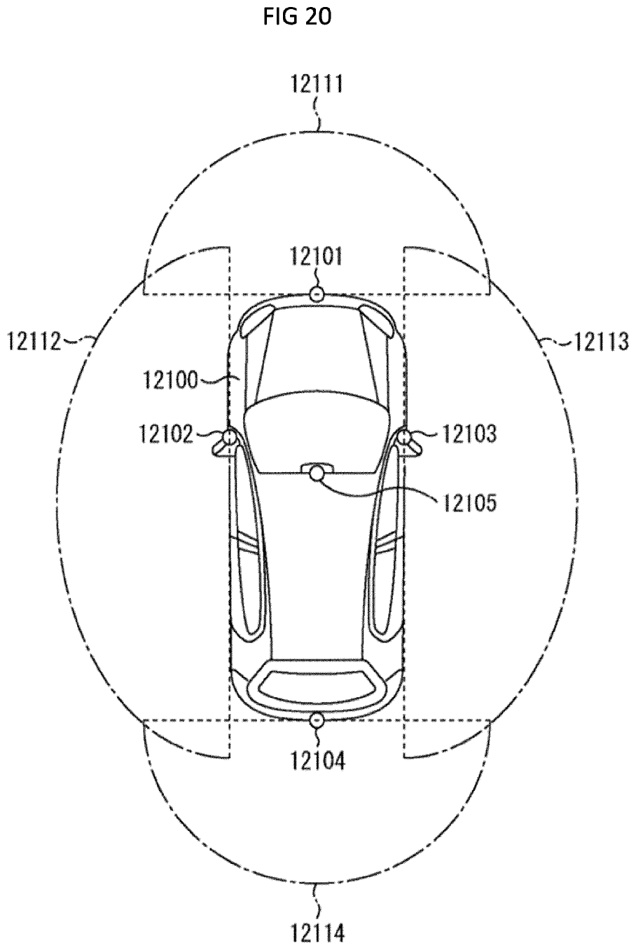

FIG. 19 is a block diagram depicting an example of schematic configuration of a vehicle control system as an example of a system to which the technology according to an embodiment of the present disclosure can be applied.

The vehicle control system 12000 includes a plurality of electronic control units connected to each other via a communication network 12001. In the example depicted in FIG. 19, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. The outside-vehicle information detecting unit 12030 can be connected with an imaging section 12031. The outside-vehicle information detecting unit 12030 makes the imaging section 12031 imaging an image of the outside of the vehicle and receives the imaged image. Based on the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include an image sensor or a solid-state imaging device with an image sensor including pixel circuits according to the embodiments of the present disclosure. The light received by the imaging section 12031 may be visible light or may be invisible light such as infrared rays or the like.

The in-vehicle information detecting unit 12040 detects information about the inside of the vehicle and may be or may include an image sensor or a solid-state imaging device with an image sensor according to the embodiments of the present disclosure. The in-vehicle information detecting unit 12040 is, for example, connected with a driver state detecting section 12041 that detects the state of a driver. The driver state detecting section 12041, for example, includes a camera that includes the solid-stage imaging device and that is focused on the driver. Based on detection information input from the driver state detecting section 12041, the in-vehicle information detecting unit 12040 may calculate a degree of fatigue of the driver or a degree of concentration of the driver or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040 and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 based on the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 19, an audio speaker 12061, a display section 12062, and an instrument panel 12063 are illustrated as the output device. The display section 12062 may, for example, include at least one of an on-board display or a head-up display.

FIG. 20 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 20 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including an image sensor or a solid-state imaging device with an image sensor including pixel circuits according to the embodiments of the present disclosure.

For example, the microcomputer 12051 can determine a distance to each three-dimensional object within the imaging ranges 12111 to 12114 and a temporal change in the distance (relative speed with respect to the vehicle 12100 on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062 and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying an image sensor or a solid-state imaging device with an image sensor including pixel circuits according to the embodiments of the present disclosure, high temporal resolution can be combined with low contrast sensitivity non-uniformity.

Additionally, embodiments of the present technology are not limited to the above-described embodiments, but various changes can be made within the scope of the present technology without departing from the gist of the present technology.

The image sensor with pixel circuits according to the present disclosure may be any device used for analyzing and/or processing radiation such as visible light, infrared light, ultraviolet light, and X-rays. For example, a solid-state imaging device including an image sensor with pixel circuits according to the embodiments may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device including an image sensor with pixel circuits according to the embodiments may be a device for capturing an image to be provided for appreciation, such as a digital camera, a smart phone, or a mobile phone device having a camera function. In the field of traffic, for example, the solid-state imaging device including an image sensor with pixel circuits according to the embodiments may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the image sensor with pixel circuits according to the embodiments may be integrated in any type of sensor that can be used in devices provided for home appliances such as TV receivers, refrigerators, and air conditioners to capture gestures of users and perform device operations according to the gestures. Accordingly, the image sensor with pixel circuits according to the embodiments may be integrated in home appliances such as TV receivers, refrigerators, and air conditioners and/or in devices controlling the home appliances. Furthermore, in the field of medical and healthcare, the image sensor with pixel circuits according to the embodiments may be integrated in any type of sensor, e.g., a solid-state image device, provided for use in medical and healthcare, such as an endoscope or a device that performs angiography by receiving infrared light.

In the field of security, the image sensor with pixel circuits according to the embodiments can be integrated in a device provided for use in security, such as a monitoring camera for crime prevention or a camera for person authentication use. Furthermore, in the field of beauty, an image sensor with pixel circuits according to the embodiments can be used in a device provided for use in beauty, such as a skin measuring instrument that captures skin or a microscope that captures a probe. In the field of sports, an image sensor with pixel circuits according to the embodiments can be integrated in a device provided for use in sports, such as an action camera or a wearable camera for sport use or the like. Furthermore, in the field of agriculture, the image sensor with pixel circuits can be used in a device provided for use in agriculture, such as a camera for monitoring the condition of fields and crops.

The present technology can also be configured as described below:
[1] A pixel circuit (100), including a radiation sensitive circuit (110) configured to convert a change of incident radiation into a pixel voltage signal VPR, wherein the pixel voltage signal VPR increases with increasing radiation intensity; a first capacitive element (121) configured to receive the pixel voltage signal VPR at a first electrode; a second capacitive element (131) configured to receive the pixel voltage signal VPR at a first electrode simultaneously with the first capacitive element (121); a first comparator circuit (125) configured to compare a first resettable voltage at a second electrode of the first capacitive element (121) with a first threshold voltage VTH; and a second comparator circuit (135) configured to compare a second resettable voltage at a second electrode of the second capacitive element (121) with a second threshold voltage VTL.
[2] The pixel circuit according to [1], wherein the first electrode of the first capacitive element (121) and the first electrode of the second capacitive element (131) are electrically connected through a low resistive connection at least in a detection period.
[3] The pixel circuit according to any of [1] and [2], further including a reset portion (170) configured to connect, in an autozero period, the second electrode of the first capacitive element (121) with a first reference node (128) and the second electrode of the second capacitive element (131) with a second reference node (138).
[4] The pixel circuit according to any of [1] to [3], further including a first reset FET (123) with a controlled path between the second electrode of the first capacitive element (121) and a first reference node (128), and a second reset FET (133) with a controlled path between the second electrode of the second capacitive element (131) and a second reference node (138).
[5] The pixel circuit according to any of [3] to [4], wherein the first reference node (128) is in an output path of the first comparator circuit (125) and the second reference node (138) is in an output path of the second comparator circuit (135).
[6] The pixel circuit according to any of [4] to [5], wherein the first reset FET (123) and the second reset FET (133) have a same channel type, and wherein the first reset FET (123) and the second reset FET (133) are simultaneously controllable through a single autozero switch signal AZSW.
[7] The pixel circuit according to any of [4] to [5], wherein the first reset FET (123) and the second reset FET (133) have complementary channel types, and wherein the first reset FET (123) and the second reset FET (133) are simultaneously controllable through complementary autozero switch signals AZSW, xAZSW.
[8] The pixel circuit according to any of [1] to [7], further including a first multiplexer (124) configured to apply a first threshold defining voltage VT1 defining the first threshold voltage VTH to the first comparator circuit (125) in a detection period and a first autozero voltage VZ1 to the first comparator circuit (125) in an autozero period; and a second multiplexer (134) configured to apply a second threshold defining voltage VT2 defining the second threshold voltage VTL to the second comparator circuit (135) in the detection period and a second autozero voltage VZ2 to the second comparator circuit (135) in the autozero period.
[9] The pixel circuit according to [8], wherein the first autozero voltage VZ1 and the second autozero voltage VZ2 are equal.
[10] The pixel circuit according to [8], wherein the first autozero voltage VZ1 and the second autozero voltage VZ2 are different.
[11] The pixel circuit according to any of [1] to [10], wherein the first comparator circuit (125) includes a first amplifier transistor (126) and a first load transistor (127), wherein controlled paths of the first amplifier transistor (126) and the first load transistor (127) are electrically connected in series between a positive pixel supply voltage VDDH and a reference potential VSS, wherein the second electrode of the first capacitive element (121) is connected to a gate of the first amplifier transistor (126), and wherein a gate of the first load transistor (127) is configured to receive a first threshold defining voltage VT1 in a detection period; and wherein the second comparator circuit (135) includes a second amplifier transistor (136) and a second load transistor (137), wherein controlled paths of the second amplifier transistor (136) and the second load transistor (137) are electrically connected in series between the positive pixel supply voltage VDDH and the reference potential VSS, wherein the second electrode of the second capacitive element (131) is connected to a gate of the second amplifier transistor (136), and wherein a gate of the second load transistor (137) is configured to receive the second threshold voltage VTL in the detection period.
[12] The pixel circuit according to [11], wherein the first amplifier transistor (126) is a pFET, wherein the first load transistor (127) is an nFET, and wherein the controlled path of the first load transistor (127) is connected between the controlled path of the first amplifier transistor (126) and the reference potential VSS, or wherein the first amplifier transistor (126) is an nFET, wherein the first load transistor (127) is a pFET, and wherein the controlled path of the first load transistor (127) is connected between the positive pixel supply potential VDDH and the controlled path of the first amplifier transistor (126).
[13] The pixel circuit according to any of [11] and [12], wherein the second amplifier transistor (136) is a pFET, wherein the second load transistor (137) is an nFET, and wherein the controlled path of the second load transistor (137) is connected between the controlled path of the second amplifier transistor (136) and the reference potential VSS, or wherein the second amplifier transistor (136) is an nFET, wherein the second load transistor (137) is a pFET, and wherein the controlled path of the second load transistor (137) is connected between the positive pixel supply potential VDDH and the controlled path of the second amplifier transistor (136).
[14] The pixel circuit according to any of [1] to [13], including a pixel logic circuit (160) configured to output an active request signal in response to an active output signal CO1 of the first comparator circuit (125) and/or in response to an active output signal CO2 of the second comparator circuit (135).
[15] The pixel circuit according to any of [1] to [14], including a pixel logic circuit (160) configured to control resetting the voltage on the second electrode of the first capacitive element (121) and resetting the voltage on the second electrode of the second capacitive element (131) in an autozero period starting in response to receiving an active group acknowledgement signal.
[16] The pixel circuit according to any of [1] to [15], including a pixel logic circuit (160) configured to output an active autozero signal AZ for an autozero period in response to receiving an active acknowledgement signal.
[17] An image sensor (10) including pixel circuits (100), wherein each pixel circuit (100) includes a radiation sensitive circuit (110) configured to convert a change of incident radiation into a pixel voltage signal VPR, wherein the pixel voltage signal VPR increases with increasing radiation intensity; a first capacitive element (121) configured to receive the pixel voltage signal VPR at a first electrode; a second capacitive element (131) configured to receive the pixel voltage signal VPR at a first electrode simultaneously with the first capacitive element (121); a first comparator circuit (125) configured to compare a first resettable voltage at a second electrode of the first capacitive element (121) with a first threshold voltage VTH; and a second comparator circuit (135) configured to compare a second resettable voltage at a second electrode of the second capacitive element (121) with a second threshold voltage VTL.

1. A pixel circuit, comprising:
a radiation sensitive circuit configured to convert a change of incident radiation into a pixel voltage signal VPR, wherein the pixel voltage signal VPR increases with increasing radiation intensity;
a first capacitive element configured to receive the pixel voltage signal VPR at a first electrode;
a second capacitive element configured to receive the pixel voltage signal VPR at a first electrode simultaneously with the first capacitive element;
a first comparator circuit configured to compare a first resettable voltage at a second electrode of the first capacitive element with a first threshold voltage VTH; and
a second comparator circuit configured to compare a second resettable voltage at a second electrode of the second capacitive element with a second threshold voltage VTL.

2. The pixel circuit according to claim 1,
wherein the first electrode of the first capacitive element and the first electrode of the second capacitive element are electrically connected through a low resistive connection at least in a detection period.

3. The pixel circuit according to claim 1, further comprising:
a reset portion configured to connect, in an autozero period, the second electrode of the first capacitive element with a first reference node and the second electrode of the second capacitive element with a second reference node.

4. The pixel circuit according to claim 1, further comprising:
a first reset FET with a controlled path between the second electrode of the first capacitive element and a first reference node, and a second reset FET with a controlled path between the second electrode of the second capacitive element and a second reference node.

5. The pixel circuit according to claim 3, wherein
the first reference node is in an output path of the first comparator circuit and the second reference node is in an output path of the second comparator circuit.

6. The pixel circuit according to claim 4,
wherein the first reset FET and the second reset FET have a same channel type, and wherein the first reset FET and the second reset FET are simultaneously controllable through a single autozero switch signal AZSW.

7. The pixel circuit according to claim 4,
wherein the first reset FET and the second reset FET have complementary channel types, and wherein the first reset FET and the second reset FET are simultaneously controllable through complementary autozero switch signals AZSW, xAZSW.

8. The pixel circuit according to claim 1, further comprising.
a first multiplexer configured to apply a first threshold defining voltage VT1 defining the first threshold voltage VTH to the first comparator circuit in a detection period and a first autozero voltage VZ1 to the first comparator circuit in an autozero period; and
a second multiplexer configured to apply a second threshold defining voltage VT2 defining the second threshold voltage VTL to the second comparator circuit in the detection period and a second autozero voltage VZ2 to the second comparator circuit in the autozero period.

9. The pixel circuit according to claim 8,
wherein the first autozero voltage VZ1 and the second autozero voltage VZ2 are equal.

10. The pixel circuit according to claim 8,
wherein the first autozero voltage VZ1 and the second autozero voltage VZ2 are different.

11. The pixel circuit according to claim 1,
wherein the first comparator circuit comprises a first amplifier transistor and a first load transistor, wherein controlled paths of the first amplifier transistor and the first load transistor are electrically connected in series between a positive pixel supply voltage VDDH and a reference potential VSS, wherein the second electrode of the first capacitive element is connected to a gate of the first amplifier transistor, and wherein a gate of the first load transistor is configured to receive a first threshold defining voltage VT1 in a detection period; and
wherein the second comparator circuit comprises a second amplifier transistor and a second load transistor, wherein controlled paths of the second amplifier transistor and the second load transistor are electrically connected in series between the positive pixel supply voltage VDDH and the reference potential VSS, wherein the second electrode of the second capacitive element is connected to a gate of the second amplifier transistor, and wherein a gate of the second load transistor is configured to receive the second threshold voltage VTL in the detection period.

12. The pixel circuit according to claim 11,
wherein the first amplifier transistor is a p channel FET, wherein the first load transistor is an n channel FET, and wherein the controlled path of the first load transistor is connected between the controlled path of the first amplifier transistor and the reference potential VSS, or
wherein the first amplifier transistor is an n channel FET, wherein the first load transistor is a p channel FET, and wherein the controlled path of the first load transistor is connected between the positive pixel supply potential VDDH and the controlled path of the first amplifier transistor.

13. The pixel circuit according to claim 11,
wherein the second amplifier transistor is a p channel FET, wherein the second load transistor is an n channel FET, and wherein the controlled path of the second load transistor is connected between the controlled path of the second amplifier transistor and the reference potential VSS, or
wherein the second amplifier transistor is an n channel FET, wherein the second load transistor is a p channel FET, and wherein the controlled path of the second load transistor is connected between the positive pixel supply potential VDDH and the controlled path of the second amplifier transistor.

14. The pixel circuit according to claim 1, further comprising:
a pixel logic circuit configured to output an active request signal in response to an active output signal CO1 of the first comparator circuit and/or in response to an active output signal CO2 of the second comparator circuit.

15. The pixel circuit according to claim 1, further comprising:
a pixel logic circuit configured to control resetting the voltage on the second electrode of the first capacitive element and resetting the voltage on the second electrode of the second capacitive element in an autozero period starting in response to receiving an active group acknowledgement signal.

16. The pixel circuit according to claim 1, further comprising.
a pixel logic circuit configured to output an active autozero signal AZ for an autozero period in response to receiving an active acknowledgement signal.

17. An image sensor comprising pixel circuits, wherein each pixel circuit comprises:
a radiation sensitive circuit configured to convert a change of incident radiation into a pixel voltage signal VPR, wherein the pixel voltage signal VPR increases with increasing radiation intensity;
a first capacitive element configured to receive the pixel voltage signal VPR at a first electrode;
a second capacitive element configured to receive the pixel voltage signal VPR at a first electrode simultaneously with the first capacitive element;
a first comparator circuit configured to compare a first resettable voltage at a second electrode of the first capacitive element with a first threshold voltage VTH; and
a second comparator circuit configured to compare a second resettable voltage at a second electrode of the second capacitive element with a second threshold voltage VTL.
